(19) United States
(12) Patent Application Publication
(10) Pub. No.: US 2019/0124071 A1
(43) Pub. Date: Apr. 25, 2019

(54) ACCESS TO NETWORK DATA FROM A PLURALITY OF SOURCES USING A SINGLE IDENTIFICATION VALUE

(71) Applicant: Closeup, Inc., Las Vegas, NV (US)

(72) Inventor: Oliver Michael Haeusler, Las Vegas, NV (US)

(21) Appl. No.: 16/155,245

(22) Filed: Oct. 9, 2018

Related U.S. Application Data
(60) Provisional application No. 62/574,473, filed on Oct. 19, 2017.

(51) Int. Cl. H04L 29/06; H04N 21/2662

(52) U.S. Cl. CPC H04L 63/0815; H04L 65/607; H04L 63/10; H04N 21/2662; H04L 65/608

(57) ABSTRACT

A method for accessing network data from a plurality of sources using a single identification value. The method may include the steps of: receiving the single identification value at a control computer from an application running in a web page on a client computer via a network; searching a database for a match of the identification value; and sending a collection to the client computer via the network in response to matching the identification value in the database. The collection may include a plurality of resources related to the identification value in the database. At least two of the resources may identify at least two other computers on the network that provide data to the web page. The other computers may provide distinct services.

This application relates to U.S. Provisional Application No. 62/574,473, filed Oct. 19, 2017, which is hereby incorporated by reference in its entirety.

### FIELD OF THE INVENTION

The invention relates to communication systems generally and, more particularly, to a method and/or apparatus for implementing access to network data from a plurality of sources using a single identification value.

### BACKGROUND

A conventional method of implementing media content access in a client, such as a web browser and an application program, is by using a uniform resource locator associated with a media content item on a computer. The computer is accessed by the client to communicate the media content. However, existing media content access technology faces some difficulties. When a plurality of related media content items are accessed, each media content item is associated with a distinct uniform resource locator. For example, viewers access a television program at one uniform resource locator and talk about the television program in a video chat room at a different uniform resource locator. In another example, one or more media content items are communicated between a plurality of clients and source computers, resulting in a complex mesh of uniform resource locators.

It would be desirable to implement access to network data from a plurality of sources using a single identification value.

### SUMMARY

The invention concerns a method for accessing network data from a plurality of sources using a single identification value. The method may include the steps of: receiving the single identification value at a control computer from an application running in a web page on a client computer via a network; searching a database for a match of the identification value; and sending a collection to the client computer via the network in response to matching the identification value in the database. The collection may include a plurality of resources related to the identification value in the database. At least two of the resources may identify at least two other computers on the network that provide data to the web page. The other computers may provide distinct services.

### BRIEF DESCRIPTION OF THE FIGURES

Embodiments of the invention will be apparent from the following detailed description and the appended claims and drawings in which:

FIG. 1 is a diagram of a system in accordance with an example embodiment of the invention;

FIG. 2 is a diagram of a method for providing web pages in accordance with an example embodiment of the invention;

FIG. 3 is a diagram of a display at a computer in accordance with an example embodiment of the invention;

FIG. 4 is a diagram of a method for determining an identification value in accordance with an example embodiment of the invention;

FIG. 5 is a diagram of a method for processing the identification value in accordance with an example embodiment of the invention;

FIG. 6 is a diagram of a method for processing a collection and information in accordance with an example embodiment of the invention;

FIG. 7 is a diagram of a single web page in accordance with an example embodiment of the invention;

FIG. 8 is a diagram of multiple web pages virtually bundled together in accordance with an example embodiment of the invention;

FIG. 9 is a diagram illustrating another system in accordance with an example embodiment of the invention;

FIG. 10 is a diagram of a method for bundling content in accordance with an example embodiment of the invention;

FIG. 11 is a diagram of a method for a live video broadcast in accordance with an example embodiment of the invention; and

FIG. 12 is a diagram of the computer of FIG. 1 in accordance with an example embodiment of the invention.

### DETAILED DESCRIPTION OF THE EMBODIMENTS

Embodiments of the present invention include providing access to network data from a plurality of sources using a single identification value that may (i) link common subject matter to a single identification value, (ii) link multiple content to the identification value, (iii) link different types of content, (iv) allow developers to work independently of where each content item connects and/or (v) operate with existing web browsers.

Various embodiments of the invention generally provide a method and/or system for creating of a collection of at least two uniform resource locators (URLs) and associating a unique identification value with the collection. Each of the at least two uniform resource locators may be associated with a different content item. The invention may further provide electronically accessing the at least two uniform resource locators on one or more client computers and server computers, by using the unique identification value instead of individual uniform resource locators.

Instead of a developer knowing where a video source is located, where a chat server is located and where a comments server is located, the developer may only know a common subject that all of the content items target. While using the system, the developer may identify what program, website, hashtag, etc. to target with the media content (e.g., what the users watch/talk about). The single identification value generally identifies a subject instead the server locations where each individual content item is found.

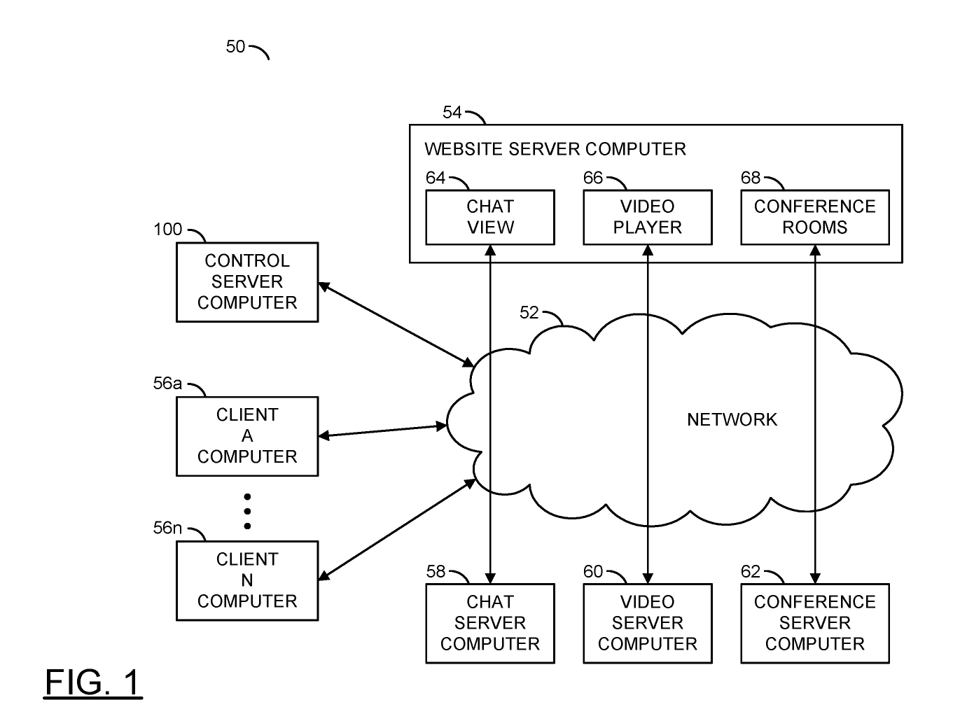

Referring to FIG. 1, a diagram of a system 50 is shown in accordance with an example embodiment of the invention. The system (or apparatus) 50 may implement a set of computers in communication with each other through one or more networks. The system 50 generally comprises a block (or circuit) 52, one or more blocks (or circuits) 54 (one shown for clarity), multiple blocks (or circuits) 56a-56n, one or more blocks (or circuits) 58 (one shown for clarity), one or more blocks (or circuits) 60 (one shown for clarity), one or more blocks (or circuits) 62 (one shown for clarity) and a block (or circuit) 100. Each circuit 54-100 may be connected to the circuit 52.

The circuit 52 may implement a communication network. In various embodiments, the network 52 may be the Internet, a wide area network, a local area network, or any combination thereof. The network 52 is generally operational to provide communications between the circuits 54-100. The communications supported by the network 52 may include the Internet Protocol (IP), the Hypertext Transfer Protocol (HTTP), the File Transfer Protocol (FTP), Peer-to-Peer protocol (P2P), and similar network communications protocols.

The circuit 54 may implement one or more website server computers. The circuit 54 is generally operational to store a variety of web pages and provide the web pages when requested to the circuits 56a-56n. Each web page may include, for example, one or more of a chat view 64 capability, a video player 66 capability and a conference room 68 capability. Other capabilities may be included in the web pages to meet the design criteria of a particular application.

Each circuit 56a-56n may implement a client computer. The computers 56a-56n are generally operational to request the web pages from the computer 54 and present the content to users of the computers 56a-56n. The content may include, but is not limited to audio content, video content, textual content and/or other types of content. In some situations, the content may be provided one-way to the computers 56a-56n, for example as a streaming movie. In other situations, the content may be two-way interactive, for example as a chat room interaction. Each computer 56a-56n may include, but is not limited to, server computers, workstations, personal computers, laptop computers, notebook computers, palm computers, personal digital assistants, portable electronic devices, battery powered devices, cellular telephones, wireless devices, game platforms and/or peripheral devices.

The circuit 58 may implement one or more chat server computers. The chat computer 58 is generally operational to host multiple chat rooms. Participation in the change rooms may be accomplished through a chat view application, such as the chat view 64 executed by the computers 56a-56n.

The circuit 60 may implement one or more video server computers. The video content computer 60 is generally operational to host multiple video content. The video content may be viewed on a video player application, such as the video player 66 executed by the computers 56a-56n. The video content may be live content and/or playback (or prerecorded) content.

The circuit 62 may implement one or more conference server computers. The conference computer 62 is generally operational to host multiple conferences. Participation in the conferences may be accomplished through a conference room application, such as the conference rooms 68 executing by the computers 56a-56n.

The circuit 100 may implement a control server computer. The control computer 100 is generally operational to provide linking of the various network data content (e.g., the chat data, the video data, the conference data, etc.) to unique identification (or identifier) values. The computer 100 may be configured to (i) receive a single identification value from an application running in a web page on a client computer via the network, (ii) search a database for a match of the identification value and (iii) send a collection to the client computer via the network in response to matching the identification value in the database. The collection generally includes a plurality of resources related to the identification value in the database. At least two resources may identify at least two other computers on the network that provide data to the web page. The other computers may provide distinct services. The computer 100 may include, but is not limited to, server computers, workstations, personal computers, laptop computers, notebook computers, palm computers and/or cloud servers.

The data (or content) items generally include, but are not limited to, live media, on-demand media, time-shifted media, interactive media, screen content media, streaming video, streaming audio, recorded video, recorded audio, images, text, files and/or other media types. The content is generally stored among the computers 58-62 and communicated (or transferred) to the computers 56a-56n based on collections provided by the computer 100 and linked to the web pages accessed from the computer 54. In various embodiments, the computers 58-62 may provide distinct services. The communications of the content may include, but is not limited to uploading, downloading, streaming, transmitting, forwarding, routing and/or other types of transfers.

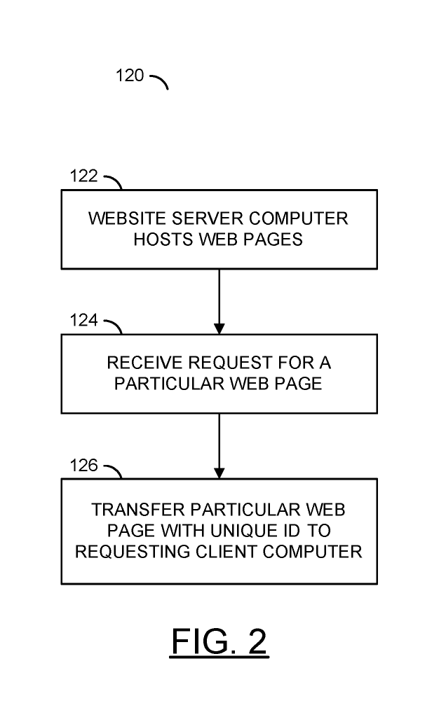

Referring to FIG. 2, a diagram of an example method 120 for providing web pages is shown in accordance with an example embodiment of the invention. The method (or process) 120 may be implemented in the computer 54. The method 120 generally comprises a step (or state) 122, a step (or state) 124 and a step (or state) 126.

In the step 122, the computer 54 may host multiple web pages on one or more storage media. The computer 54 may receive a request from one or more of the computers 56a-56n for a particular web page in the step 124. The computer 54 may respond to the request(s) by transferring the particular web page to the requesting computer(s) 56a-56n. As part of the transfer, the computer 54 may include a single unique identification value assigned to the particular web page.

The identification value may be contained in meta tags, query programs, fragment identifiers or the like. If no embedded identification value is assigned, the uniform resource locator of the particular web page may be used as the identification value. The identification values are generally set by the web page developers. The identification values may be publically accessible (e.g., the uniform resource locators) or private in regards to the general public. An example of a private identification value may be opaque identification values. Other types of identification values may be implemented to meet the design criteria of a particular application.

In various embodiments, multiple identification values may be utilized in a single website. For example, a news web page may include multiple articles where each article has an associated identification value. If multiple resources are virtually linked with the same shared identification value, a collection containing the resources (e.g., an access token) may be received by the computers 56a-56n instead of handling multiple connections to multiple server computers manually. In various embodiments, the collection may be signed by the computer 100 so that the computers 56a-56n may not modify the collection. The resource-producing computers 58-62 may verify the signature provided by the computer 100. In other embodiments, the collection may be encrypted by the computer 100 with an encryption key so that the computers 56a-56n may not read the collection. The resource producing computers 58-62 may decrypt the collection provided by the computer 100 with the key. If a collection is accepted, the resource-producing computer 58-62 may read data from the collection and establish connections between the components per the data. Other verification technologies may be implemented to meet the design criteria of a particular application.

The web pages may include hyper-text markup language (HTML) code, wherein, as often used in media players and service development kits (SDKs), the HTML code may include an HTML HEAD section (e.g., <HEAD> to </HEAD>), an HTML script tag (e.g., script async scr=“https://vendor.com/sdk.js”></script>) and an HTML meta tag (e.g., meta property=“sdk:unique-identifier” content=xyz.tv/television_program”/>). The web pages may also contain embedded views (e.g., iframes, divs, and so on. An iframe (inline frame) generally places another HTML document inside the frame. An iframe may have a defined functionality (e.g., a chat, video player, conference room, comments, or the like). The iframes may be consumers (e.g., players), producers (e.g., cameras, microphones, screen-for-screen sharing, etc.). The iframes may also include multiple resources (e.g., change, comments, conferences, mixers, as the like). The div tags may define divisions or sections in an HTML document. The div tags may also be used as containers for other HTML elements to style the elements with CSS or to perform certain tasks with JavaScript. In various embodiments, the divs may be used instead of the iframes. The web pages may also contain embedded containers.

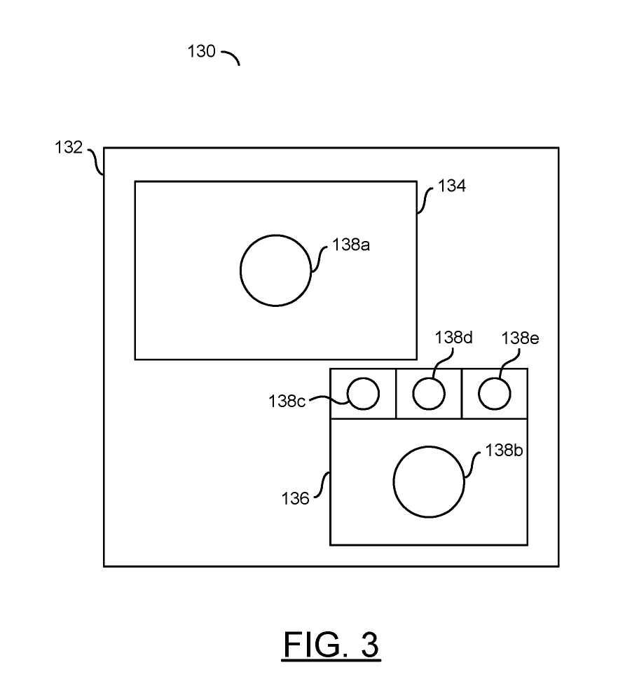

Referring to FIG. 3, a diagram of an example display 130 at a computer 56a-56n is shown in accordance with an example embodiment of the invention. The display 130 may be shown to a user through a web browser (or application program) at a user interface 132. The user interface 132 may display at least two media content items 138a-138e. The at least two media content items 138a-138e (e.g., 138a and 138b) may pertain to a common context, such as, but not limited to, the same social media post, the same television (TV) program, and/or the same web page displayed in the user interface 132. For example, as often used in interactive TV (ITV), the user interface 132 may display to the user (i) a media content item 138a pertaining to a TV program 134 and (ii) at least one other media content item 138b pertaining to a video room 136. By way of example, the video room 136 may be a virtual video room where users may meet in a video conference, and the media content items 138a and 138b generally pertain to the same TV program 134. In various embodiments, one or more of the content items 138c-138e may also be related to the TV program 134. In other embodiments, one or more of the content items 138c-138e may by shown independent of the TV program 134. Various other embodiments may also be directed toward other clients besides the clients using web browser user interfaces 132. The other clients may include mobile clients and desktop clients, where the client may display to the user a view, a window, an app activity, and/or an app fragment.

An example data structure of an example collection may be implemented as a JavaScript object notation (JSON) file. The JSON file (or container) generally includes a unique identification value (e.g., xyz.tv/television_program) and a collection of uniform resource locators (e.g., https://xyz.tv/player.television_program-live-stream.webm and xyz.tv/videoroom/television_program.sdp.) Each uniform resource locator may be associated with a media content item 138a-138e (FIG. 3). The unique identification value may be associated with a context, such as the TV program 134 (FIG. 3).

Various embodiments may employ other data structures and/or other file containers. For example, some data structures may include, but are not limited to, an extensible markup language (XML) file, a yet another markup language (YAML) file, a protocol buffers file, and/or a plain text file. The data structures may also include individual properties, a map structure, JSON objects, JSON arrays, and other structural elements in one or more individual files, as often used when describing related data elements. Each data structure may or may not include additional data elements.

In some embodiments, the filename of the data structure file may or may not include the unique identification value. In another embodiment, a database may include the file, the unique identification value, the collection, and the uniform resource locators. In yet another embodiment, a system memory may include the file, the unique identification value, the collection, and the uniform resource locators.

In various embodiments, each uniform resource locator may be a unique identifier, a universally unique identifier (UUID), a globally unique identifier (GUID), a hash and/or any other identifier that is unique within the system 50. In various embodiments, the unique identification value may be a uniform resource locator utilized for accessing the file, the unique identifier, the collection, a unique uniform resource locator of the requesting computer, a unique alphanumeric string, a random number, a file name, a universally unique identifier, a globally unique identifier, a property of a view, an attribute in a session description protocol (SDP) and/or a hash calculated from any of the above. The unique identification value may be descriptive. The unique identification value may also be opaque. The unique identification value, the collection, and the uniform resource locators may be distributed across a plurality of devices, such as the computers 56a-56n and/or the computer 100.

In various embodiments, the data structures may include at least two uniform resource locators. The uniform resource locators may have a common path, prefix, and/or suffix, and may reside in a directory structure and/or a file system. The identification value may include the common path, prefix, and suffix of the at least two uniform resource locators.

In some embodiments, the unique identification value may include a particular uniform resource locator of the at least two uniform resource locators. The file container may include a collection including one or more of the uniform resource locators. The particular uniform resource locator may be associated with the file container, and whereby the particular uniform resource locator may be used for accessing of the file container. In various embodiments, the computers 56a-56n may access the entire collection. In another embodiments, the computers 56a-56n may access a subset of the at least two uniform resource locators in the collection. The unique identification value may include a serialized version of the at least two uniform resource locators. The serialized version of the at least two uniform resource locators may be used as the unique identification value.

In some embodiments, the data structure, the file, the unique identification value, the collection, and the uniform resource locators may be encrypted and signed. In other embodiments, the data structure may be manipulated by the computer 100 before sending a response to the computers 56a-56n. The computers 56a-56n may receive a subset of the data in the data structure. For example, the computers 56a-56n may receive only the uniform resource locator that is appropriate for accessing a media content item.

In various embodiments, an authentication token, such as a JSON web token (JWT), an application programming interface (API) key, a certificate, an OpenID token, and/or a token obtained from an OAuth workflow may be included for accessing of the file container, the unique identification value, the collection, and the uniform resource locators. In various embodiments, the unique identification value may include the authentication token.

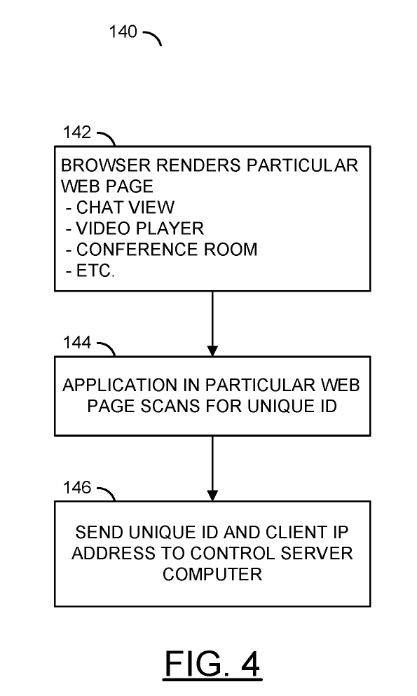

Referring to FIG. 4, a diagram of an example method 140 for determining the identification value is shown in accordance with an example embodiment of the invention. The method (or process) 140 may be implemented in the computers 54a-54n. The method 140 generally comprises a step (or state) 142, a step (or state) 144 and a step (or state) 146.

In the step 142, a browser executing in a computer 56a-56n may render the particular web page received from the computer 54 via the network 52. In various embodiments, the web page may be rendered by an app (e.g., on a cellular phone) or a desktop program (e.g., web browser). The computer 56a-56n may also receive from the computer 100 a JavaScript program associated with the uniform resource locator provided in the HTML script tag. The particular web page may include a chat view capability (or application), a video player capability (or application), a conference room capability (or application) and/or other capabilities (or applications). The computers 56a-56n may execute the JavaScript program to start a workflow. The workflow may include program code that may access a collection from the computer 100. The workflow may include program code that scans the particular web page for the unique identification values in the step 144. Upon finding one or more identification values (e.g., in a meta tag), the computer 56a-56n may send the identification value(s) to the computer 100 via the network 52 in the step 146. The identification value(s) and the uniform resource locator of the computer 56a-56n may be sent to the computer 100 via an HTTP GET request.

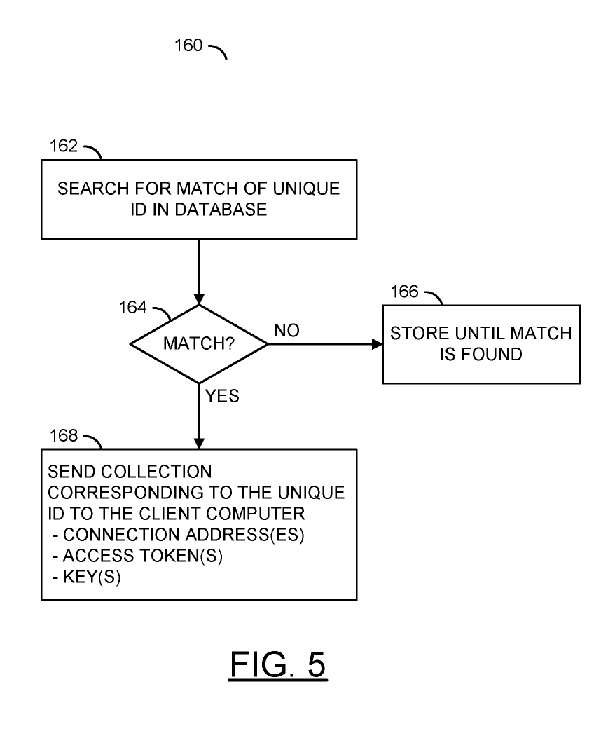

Referring to FIG. 5, a diagram of an example method 160 for processing an identification value is shown in accordance with an example embodiment of the invention. The method (or process) 160 may be implemented in the computer 100. The method 160 generally comprises a step (or state) 162, a step (or state) 164, a step (or state) 166 and a step (or state) 168.

In the step 162, the computer 100 may search a database for a match to the recently received unique identification value. The database may have a list-like structure where each line of the list contains an identification value, a function (e.g., chat, video, conference room, etc.) and a client uniform resource locator address. If no match is found in the step 164, the computer 100 may store the received identification value, the function and the client uniform resource locator address in the database and ignore the received identification value in the step 166 until a match is found. If a match is found in the step 164, the computer 100 may respond in the step 168 by calling back the requesting computer 56a-56n. In the step 168, the collection (e.g., resource locations, connection addresses, access tokens, keys, etc.) and associated instructions may be sent back to the requesting computer 56a-56n corresponding to the unique identification value of the HTTP GET request. In another embodiment, an HTTP POST request and push technologies (e.g., asynchronous JavaScript and XML (AJAX), BOSH, WebSockets, socket.io) may be used instead of the HTTP GET request.

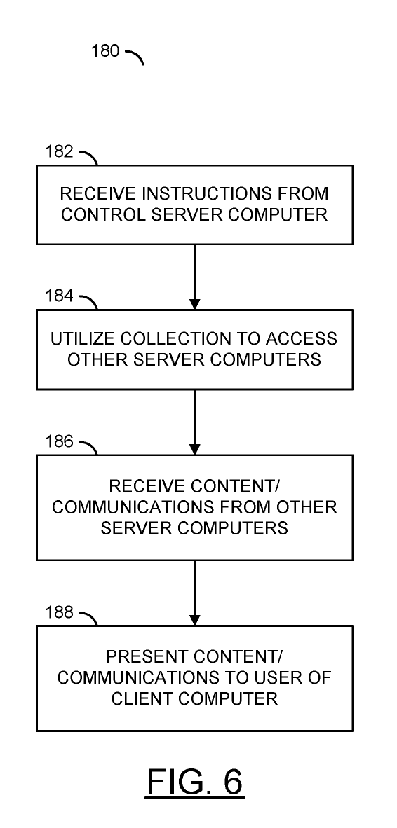

Referring to FIG. 6, a diagram of an example method 180 for processing the collection and information is shown in accordance with an example embodiment of the invention. The method (or process) 180 may be implemented in the computers 56a-56n. The method 180 generally comprises a step (or state) 182, a step (or state) 184, a step (or state) 186 and a step (or state) 188.

In the step 182, the collection and instructions transmitted by the computer 100 may be received by the requesting computer 56a-56n. The receiving computer 56a-56n may utilize the collection data in the step 184 to access the associated content in the other computers 58-62 per the accompanying instructions. The uniform resource locators in the collection are generally used to access media content items, where each uniform resource locator in the collection may be associated with a corresponding media content item. For example, if the collection specifies a video stream, the computer 56a-56n may use the uniform resource locator of the video stream to request the video stream from the video computer 60. If an access token was received from the computer 100, the computers 58-62 may validate the token, read the instructions and begin serving the specified content to the requesting computer 56a-56n. In the step 186, the computer 56a-56n may receive the content/communications identified in the collection. The content/communications may be found on the same web pages or different web pages as the content/communications are “virtually bundled” by the single identification value. The computer 56a-56n may present the content/communications to a user of the client computer in the step 188.

In various embodiments, the computers 56a-56n may use all of the uniform resource locators in the collection. In other embodiments, the computers 56a-56n may use a subset of the uniform resource locators in the collection. Furthermore, alternative embodiments may use a distinct method for starting the workflow.

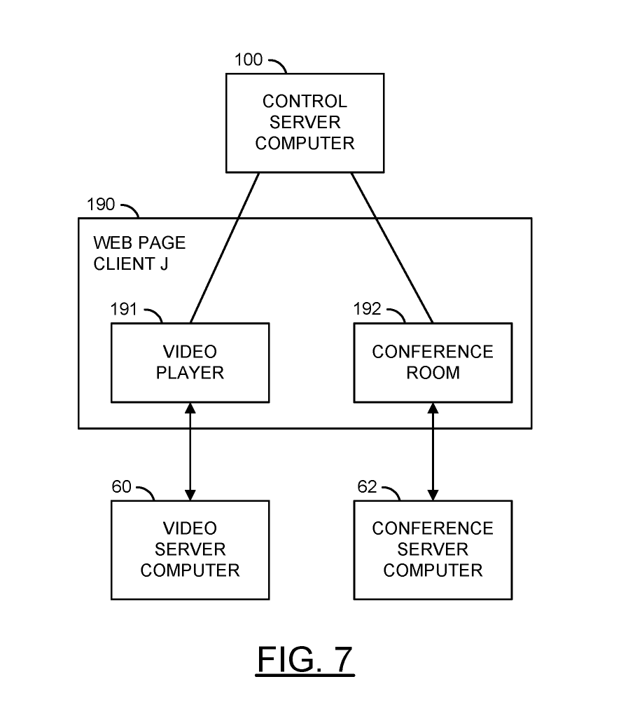

Referring to FIG. 7, a diagram of an example implementation of a single web page 190 is shown in accordance with an example embodiment of the invention. The web page 190 may be executed by a client computer 56a-56n (e.g., client computer 56j). The web page 190 generally comprises multiple (e.g., two) iframes bundled in a collection provided to the computer 56j by the computer 100. For example, the content may provide an iframe for a video player view 191 and another iframe for a conference room view 192. A content for the video player view 191 may be linked by the content to the computer 60. Another content for the conference room view 192 may be linked by the content to the computer 62.

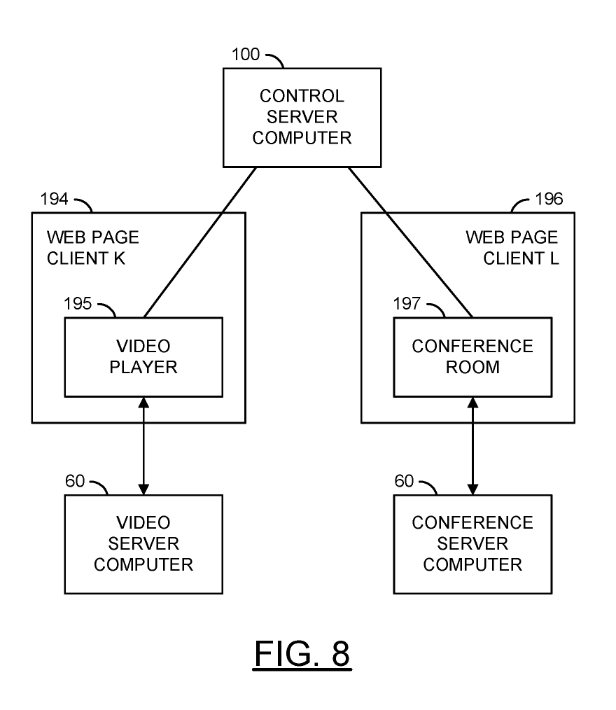

Referring to FIG. 8, a diagram of an example implementation of multiple web pages 194 and 196 virtually bundled together is shown in accordance with an example embodiment of the invention. The web page 194 may be executed by a client computer 56a-56n (e.g., client computer 56k). The web page 196 may be executed by a client computer 56a-56n (e.g., client computer 56l). The web pages 194 and 196 generally comprise one or more iframes bundled in a collection provided to the computers 56k and 561 by the computer 100. For example, the content may provide an iframe for a video player view 195 executed on the computer 56j and another iframe for a conference room view 197 executed on the computer 56l. A content for the video player view 195 may be linked by the content to the computer 60. Another content for the conference room view 197 may be linked by the content to the computer 62. The distinct content (e.g., video player and conference room) may be virtually bundled together in the collection by having each content registered with the computer 100 using the same identification value.

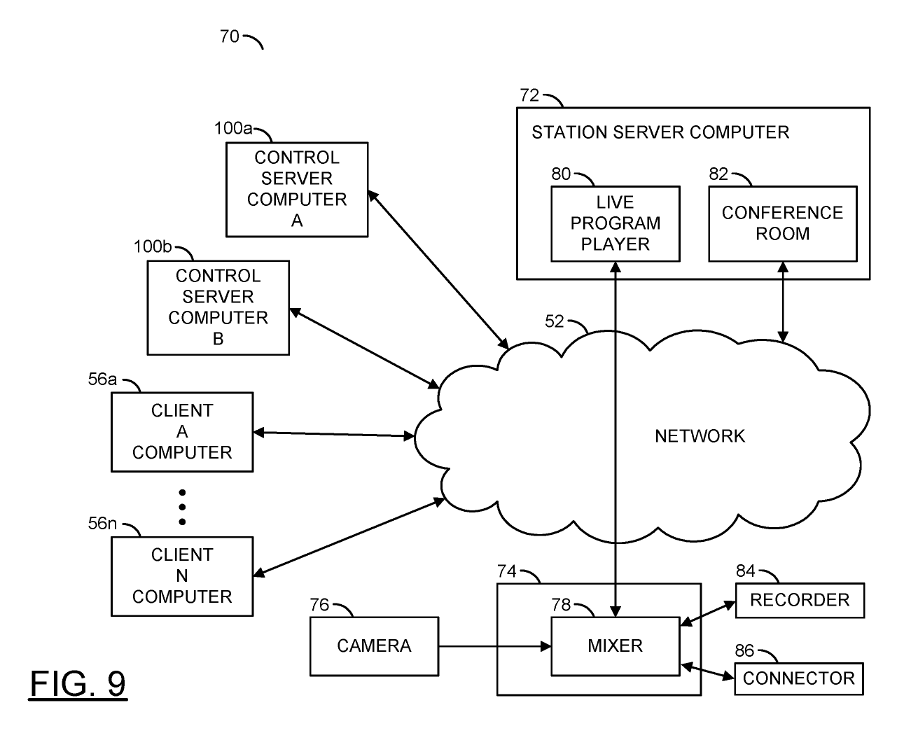

Referring to FIG. 9, a diagram illustrating an example implementation of another system 70 is shown in accordance with an example embodiment of the invention. The system (or apparatus) 70 generally comprises the network 52, a block (or circuit) 72, the computers 56a-56n, a block (or circuit) 74, a block (or circuit) 76, a block (or circuit) 78 and multiple computers 100a-100b.

The circuit 72 may implement a station service computer. In various embodiments, the computer 72 may be a television station server computer. The computer 72 may host multiple contents. For example, the computer 72 may host a live program player 80 and a conference room 82.

The circuit 74 may implement a producer computer. The computer 74 is generally operational to provide an audio/video program to the live program player 80. In various embodiments, the audio/video program may be a live program, a taped program and/or an automation program.

The circuit 76 may implement a camera. The camera 76 is generally operational to create one or more video signals and (optionally) one or more audio signals of the surrounding environment. The audio signals and the video signals may be presented to the computer 74.

The circuit 78 may implement a mixer. The mixer may be an application program executing in the computer 74. The mixer 74 is generally operational to provide common audio and/or video mixing operations.

Each computer 100a-100b may be a copy of the computer 100. Each computer 100a-100b may have access to the same list of unique identifier values. Conflict resolution techniques (e.g., block storage, and/or a stateful cluster store like Remote Dictionary Server (Redis), Consul and/or Memcached) may be used to govern access to the list.

In various embodiments, the system 70 may be implemented as a mesh of apparatuses (or devices) in a media content access system. For example, the media content access system may be a variation of the system 50 (FIG. 1). The mesh may include a plurality of distinct networks, such as an IP network, a Bluetooth network, a wireless network, and/or a cabled-connection network. The devices may include the computers 56a-56n, the computers 100a-100b, the computer 72 and the computer 74. The computers 56a-56n 72, 74 and 100a-100b may be operational to communicate with each other via the plurality of networks within the system 70. The unique identifiers may be used for accessing of a media content in the computer 74 by the computers 56a-56n and the computes 100a-100b. The computers 100a-100b may provide one or more of access, storage, caching, routing, and/or forwarding the media content items. The client computer 56a-56n and the control computers 100a-100b in the mesh may share the same context, such as television programs, audio programs and the like.

Functions of each device (e.g., the camera 76 and the mixer 78) generally determine how the media content is accessed. For example, the camera 76 may upload the media content to the client computers 56a-56n. One or more recorders 84 connected to the mixer 78 may download and store media content into the mesh. Moreover, other devices (or computers) may operate as media content server computers, media content client computers, and/or a combination thereof, where the media content may be communicated between a control computer 100a-100b and another control computer 100a-100b, between a control computer 100a-100b and a client computer 56a-56n, and between a client 56a-56n and another client computer 56a-56n. The media content may also be communicated between the client computers 56a-56n and control computers 100a-100b in a single direction and in both directions.

In various embodiments, the computers 56a-56n, 72, 74 and 100a-100b in the mesh may communicate via one or more networks simultaneously. For example, the mixer 78 may use a Bluetooth network for downloading of the media content from the camera 76. The mixer 78 may also use an IP network for uploading the media content to the computer 72. In other embodiments, one or more computers 56a-56n, 72, 74 and 100a-100b may communicate via an internal bus. One or more direct connections may also be provided to access to the media content from the computer 74.

In some embodiments, a uniform resource locator of the at least two uniform resource locators may be associated with a media content item on one or more of the computers 100a-100b. A uniform resource locator of the at least two uniform resource locators may be associated with a media content item on a computer 56a-56n. Two or more of the uniform resource locators may be associated with a media content item residing on any other apparatus in communication via the network 52.

In some embodiments, an external connector 86 may be operational to upload media content to an external provider and/or social network, such as a video streaming service, Facebook® and YouTube®. The external upload target may or may not be determined by the unique identification value.

In various embodiments, the media content may be communicated by uploading, downloading or both. The media content may be streamed in one or both directions. Multiple uniform resource locators may also be associated with a stream from the camera 76.

The client computers 56a-56n and the control computers 100a-100b in the system 70 may share the same context, wherein the context may be associated via the unique identification value. For example, the shared content may include, but is not limited to television programs, Twitter® hashtags, Facebook® posts, hypertext transfer markup language (HTML) domains, HTML pages, views, Android® app activities, and Android® app fragments.

Access to the media content may be implemented into a software development kit (SDK). Access to the media content may be implemented into a hardware, a media player, a library, a browser, and/or an operating system (OS). Other access techniques may be implemented to meet the design criteria of a particular application.

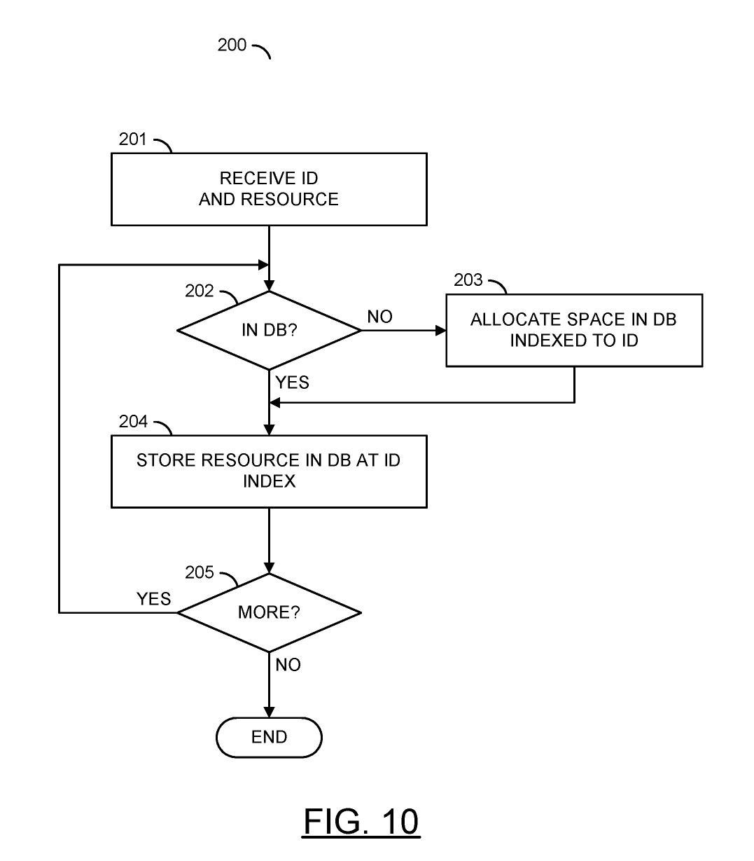

Referring to FIG. 10, a diagram of an example method 200 for bundling content is shown in accordance with an example embodiment of the invention. The method (or process) 200 may be implemented in the computers 100 and/or 100a-100b. The method 200 generally comprises a step (or state) 201, a step (or state) 202, a step (or state) 203, a step (or state) 204 and a step (or state) 205. In the following description of the method 200, the computers 100 and 100a-100b may be referred to as the computer 100.

In the step 201, the computer 100 may receive an identification value and a uniform resource locator from a requesting computer 56a-56n at a given time. The computer 100 may perform a check in the step 202 to determine if the received identification value is already in a database. If the received identification value is not found in the database, the computer 100 may allocate space in the database indexed to the received identification value. Once the received identification value is part of the database, the computer 100 may store the received resource and the uniform resource locator of the requesting computer 56a-56n in the database at the identification value index. The identification value may be duplicated if the same identification value already exists in the database. For example, the database may previously contain a line:

| ID Value | Resource | Client IP |
|---|---|---|
| 1234 | chat | 2.2.4.6 |

Upon reception of a new identification value, new resource and new client uniform resource locator at another time, the database may be updated as follows:

| ID Value | Resource | Client IP |
|---|---|---|
| 1234 | chat | 2.2.4.6 |
| 1234 | chat | 5.5.5.5 |

If the computer 100 receives more identification values and corresponding resources at additional times, the step 205 may return the method 200 back to the step 202. Otherwise, the method 200 may be ended or idled.

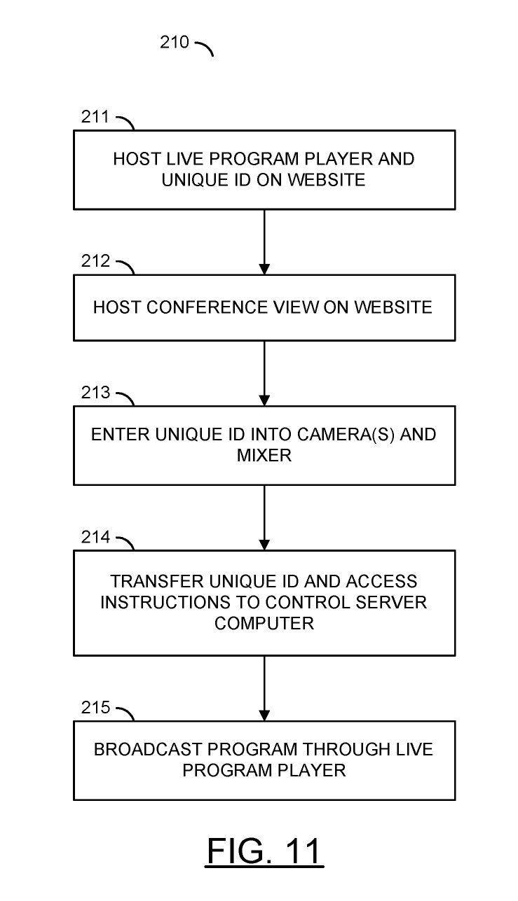

Referring to FIG. 11, a diagram of an example method 210 for a live video broadcast is shown in accordance with an example embodiment of the invention. The method (or process) 210 may be implemented in the computer 72 and the computer 74. The method 210 generally comprises a step (or state) 211, a step (or state) 212, a step (or state) 213, a step (or state) 214 and a step (or state) 215.

In the step 211, the computer 72 may host the live program player 80 on a website with a unique identification value associated with a program to be broadcasted (or streamed) over the network 52. The player resource and the unique identification value may be sent to one or more computers 100a-100b. The computer 72 may also host the conference room view 82 with the same unique identification value on the website in the step 212. The conference room resource and the unique identification value may be sent to one or more computers 100a-100b. The receiving computer(s) 100a-100b may bind the unique identification value with the player resource, the conference room resource, and the uniform resource locator of the computer 72, as described earlier.

In the step 213, an operator at the television station may enter the same unique identification value into the camera 76 and the mixer 78. The computer 74 may transfer the unique identification value, the camera resource and the mixer resource to the one or more computers 100a-100b. The receiving computer(s) 100a-100b may bind the unique identification value with the camera resource, the mixer resource, and the uniform resource locator of the computer 74. The receiving computer(s) 100a-100b may calculate the individual streams based on the function of each resource and send information to each requesting computer 56a-56n. The individual streams (or collections) may identify the uniform resource locators where the computers 56a-56n should connect to watch the broadcast and/or participate in the conference room. In some cases, the streams may include any tokens, key and/or instructions appropriate to access the content.

In the step 215, the computer 74 may broadcast the live program through the network 52 to the computers 56a-56n. The computer 72 may run the conference room associated with the live program for the computers 56a-56n logged in. Each computer 56a-56n accessing the live program and/or conference room may do so based on the single unique identification value. For example, a million viewers at the computers 56a-56n may participate in the live program and/or conference room as if virtual cabling existed between the computers 56a-56n and the computers 72 and 74. The television station may be live with the program by adding a few lines of code to the website hosted on the computer 72 to incorporate the unique identification value.

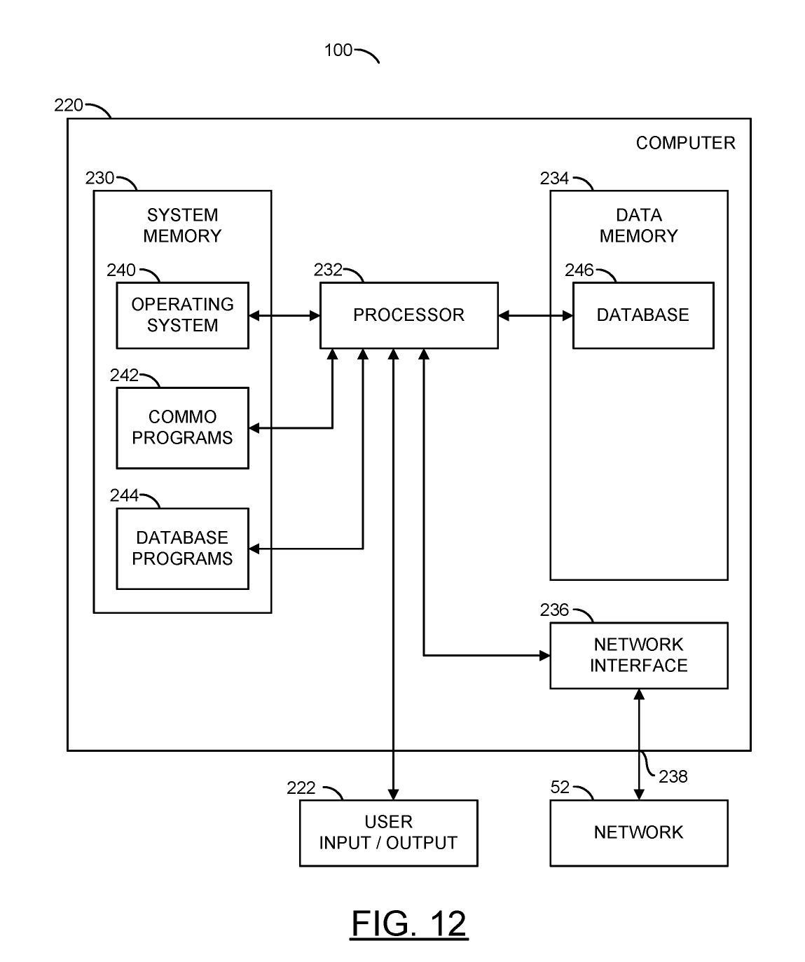

Referring to FIG. 12, a diagram of an example implementation of the computer 100 is shown in accordance with an example embodiment of the invention. The computer 100 may be representative of the computers 100a-100b.

The computer 100 generally comprises a server computer 220 and a user input/output device 222. The server computer 220 generally comprises a system memory 230, one or more processors 232, data memory 234 and a network interface circuit 236. The network interface circuit 236 may connect to the network 52 through a bidirectional interface 238 of the server computer 220.

The system memory 230 may be implemented as a non-transitory computer readable medium. The memory 230 generally stores an operating system 240, one or more communication programs 242 and one or more database maintenance programs 244. The data memory 234 may store a database 246. The communication programs 242 may be operational to communicate with the other computers 54, 56a-56n, 58, 60, 62, 72, 74, 100a and/or 100b through the network 52. The database programs 244 may be operational to add, modify and/or delete the collections of identification values/resources/URLs in the database 246.

The invention generally encompasses an aspect concerning a method for providing access to network data from a plurality of sources using a single identification value. The method may include electronically constructing, by a server computer, a data structure comprising a unique identifier associated with a collection, where (i) the collection generally comprises at least two uniform resource locators and (ii) each uniform resource locator may be associated with a media content item (or network data); utilizing, by a client computer, the unique identifier for accessing of the collection; and subsequently utilizing, by the client computer, each uniform resource locator in the at least two uniform resource locator for accessing of the media content item associated with the uniform resource locators.

In some embodiments of the method aspect described above, the accessing of the collection may comprise: sending, by the client computer, a hypertext transfer protocol GET request to the server computer to request the subset of the at least two uniform resource locators, wherein the hypertext transfer protocol GET request may carry the unique identifier; and receiving, by the client computer, a server response from the server computer, where the server response may carry the subset of the at least two uniform resource locators, corresponding to the unique identifier of the hypertext transfer protocol GET request.

In some embodiments of the method aspect described above, the client computer may utilize the unique identifier for accessing of a subset of the at least two uniform resource locators in the collection.

In some embodiments of the method aspect described above, a plurality of clients may utilize the unique identifier for accessing one or more of the at least two uniform resource locators in the collection.

In some embodiments of the method aspect described above, the unique identifier may be associated with a context common to all media content items associated with the at least two uniform resource locators in the collection.

In some embodiments of the method aspect described above, the unique identifier may be a uniform resource locator.

In some embodiments of the method aspect described above, the unique identifier may be comprised of the collection.

The invention generally encompasses a second aspect concerning an apparatus comprising a processor and a non-transitory computer readable medium. The non-transitory computer readable medium may store programming for execution by the processor, the programming generally comprises instructions to: communicate a data structure describing media content items pertaining to a common context, the data structure comprising a unique identifier and a collection of at least two unified resource locators, where (i) each uniform resource locator of the at least two uniform resource locators comprises information indicative of where an associated media content item is located and (ii) the unique identifier may be associated with the context.

In some embodiments of the apparatus aspect described above, the apparatus may comprise a server computer.

In some embodiments of the apparatus aspect described above, the apparatus may comprise a client computer.

In some embodiments of the apparatus aspect described above, the apparatus may utilize the hypertext transfer protocol for communicating the data structure.

The functions and structures illustrated in the diagrams of FIGS. 1 to 12 may be designed, modeled, emulated, and/or simulated using one or more of a conventional general purpose processor, digital computer, microprocessor, microcontroller, distributed computer resources and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally embodied in a medium or several media, for example non-transitory storage media, and may be executed by one or more of the processors sequentially or in parallel.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. A method for accessing network data from a plurality of sources using a single identification value, comprising the steps of:
receiving said single identification value at a control computer from an application running in a web page on a client computer via a network;
searching a database for a match of said identification value; and
sending a collection to said client computer via said network in response to matching said identification value in said database, wherein (i) said collection includes a plurality of resources related to said identification value in said database, (ii) at least two of said resources identify at least two other computers on said network that provide data to said web page and (iii) said other computers provide distinct services.

2. The method according to claim 1, further comprising the step of:
utilizing said resources in said collection received at said client computer to access said data from said at least two other computers.

3. The method according to claim 1, wherein (i) said web page includes a chat view application and (ii) said resources include a uniform resource locator of a chat computer that provides said data for said chat view application.

4. The method according to claim 1, wherein (i) said web page includes a video player application and (ii) said resources include a uniform resource locator of a video content computer that provides said data for said video player application.

5. The method according to claim 1, wherein (i) said web page includes a conference room application and (ii) said resources include a uniform resource locator of a conference computer that provides said data for said conference room application.

6. The method according to claim 1, wherein said identification value is a uniform resource locator provided by said client computer.

7. The method according to claim 1, wherein said identification value is an alphanumeric string.

8. The method according to claim 1, wherein said resources include a key configured to enable decryption of said data by said client computer.

9. The method according to claim 1, wherein said resources include a token configured to enable said client computer to access said data on one or more of said other computers.

10. The method according to claim 1, further comprising the steps of:
receiving said identification value a plurality of times at said control computer, wherein (i) a first reception of said identification value is associated with a first resource and (ii) a second reception of said identification value is associated with a second resource;
allocating a space in said database associated with said identification value; and
storing said first resource and said second resource in said space allocated to said identification value.

11. The method according to claim 10, wherein said first resource is a first uniform resource locator of a source of a video player application.

12. The method according to claim 11, wherein said second resource is a second uniform resource locator of conference room data corresponding to said video player application.

13. An apparatus comprising:
an interface to a network; and
a control computer configured to (i) receive a single identification value from an application running in a web page on a client computer via said network, (ii) search a database for a match of said identification value and (iii) send a collection to said client computer via said network in response to matching said identification value in said database, wherein (a) said collection includes a plurality of resources related to said identification value in said database, (b) at least two of said resources identify at least two other computers on said network that provide data to said web page and (c) said other computers provide distinct services.

14. The apparatus according to claim 13, wherein said identification value is a uniform resource locator provided by said client computer.

15. The apparatus according to claim 13, wherein said identification value is an alphanumeric string.

16. A method for accessing network data from a plurality of sources using a single identification value, comprising the steps of:
receiving a single identification value a plurality of times at a control computer via a network, wherein (i) a first reception of said identification value is associated with a first resource and (ii) a second reception of said identification value is associated with a second resource;
allocating a space in a database associated with said identification value;
storing said first resource and said second resource in said space allocated to said identification value;
receiving said identification value at said control computer from a plurality of applications running in a plurality of web page on a plurality of client computers via said network;
searching said database for a match of said identification value; and
sending a collection to said client computers via said network in response to matching said identification value in said database, wherein (i) said collection includes a plurality of resources related to said identification value in said database, (ii) at least two of said resources identify at least two other computers on said network that provide data to said web page and (iii) said other computers provide distinct services.

17. The method according to claim 16, wherein said resources are virtually bundled together by said identification value.

18. The method according to claim 17, wherein said first resource and said second are different types of resources.
